(19) United States
(12) Patent Application Publication
(10) Pub. No.: US 2008/0308388 A1
(43) Pub. Date: Dec. 18, 2008

(54) Aircraft baggage conveyor system

(75) Inventor: Frank Konig, Essen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/900,331

(22) Filed: Sep. 11, 2007

(30) Foreign Application Priority Data
Sep. 12, 2006 (DE) 10 2006 042 734.3

(51) Int. Cl. B65G 43/08; B65G 47/49

(52) U.S. Cl. 198/358

(57) ABSTRACT

The invention relates to an aircraft baggage conveyor system having containers which are of different sizes and are provided for holding and transporting pieces of baggage with different dimensions. In order to differentiate the containers of different sizes within the system and to ensure that they can be stopped reliably using simple means and in a more precisely positioned fashion than in the past taking into account their differences in length and size, it is proposed that, in order to detect and to control preferably the oversized containers within the aircraft baggage conveyor system, a magnetic sensor system is provided between the container belt and the container.

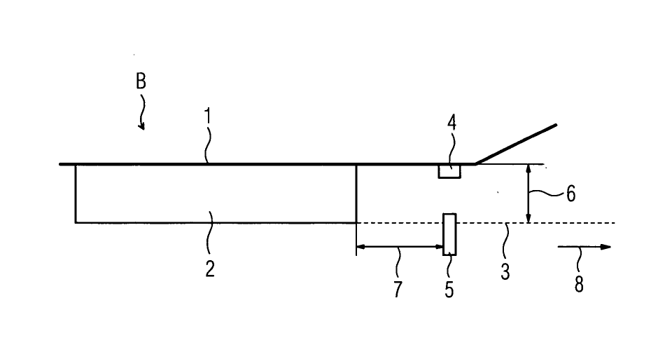

### CROSS REFERENCE TO RELATED APPLICATIONS

This application claims the benefits of German application No. 10 2006 042 734.3 filed Sep. 12, 2006, and is incorporated by reference herein in its entirety.

### FIELD OF INVENTION

The invention relates to an aircraft baggage conveyor system having containers which are of different sizes, are provided for holding and for transporting pieces of baggage with different dimensions and can be moved successively through the system on individually controllable conveyor sections of a container belt, wherein the containers are each composed of a nonmetallic shell which holds the piece of baggage and is correspondingly dimensioned and a metallic holder for the shell, and wherein photoelectric barriers are provided with which the presence of the containers can be sensed and their stopping point in the system can be specified by means of a stored program controller.

### BACKGROUND OF THE INVENTION

Baggage holding containers of different sizes are usually used in aircraft baggage conveyor systems. This allows for the fact that the dimensions of the pieces of baggage vary greatly and therefore, for example, skis and other bulky items must also be able to be transported, such as cases, rucksacks and bags. The baggage holding containers themselves are usually made of plastic in order to permit through lighting in the security systems. The metallic holders or shell bases on which the containers are fitted are available in different dimensions (1250 mm and 1600 mm) matched to the container sizes. However, for containers for transporting oversized baggage (referred to as OOG containers) a 2400 mm plastic shell is mounted on a 1600 mm metallic shell base so that the plastic shell protrudes on both sides. If all the different container types are to be conveyed without disruption in a mixed operating mode within the same system, it is necessary to ensure that the containers are detected in an absolutely reliable way for the subsequent precise positioning at predefined stopping points.

At present, the containers are positioned using photoelectric barriers. For this purpose, just before a container reaches the specified stopping point, a signal is transmitted from the light sensor of the photoelectric barrier to the stored program controller (SPS) by means of which the stopping of the container is initiated. However, in this context the reaction time (cycle time) of the stored program controller has to be taken into account, i.e. the time during which the stopping signal which is transmitted to the stored program controller is carried out. If the cycle time is too long, the containers travel beyond the planned stopping point. If the cycle time is too short as a result of very quick transmission, the containers can come to a standstill before the desired stopping point. Both variants which are due to what are referred to as the cycle time tolerances are unsatisfactory in terms of their result.

If containers of different sizes are used in the same system, a further problem occurs. It appears unavoidable to provide at all stopping points of the containers a plurality of photoelectric barriers which take into account the different sizes of the containers and stop them in a precisely positioned fashion. Since the additional photoelectric barriers are usually mounted on the same holders, the further disadvantage occurs that re-adjustments of the photoelectric barrier or of the initiator for the stopping point of a container which are possibly necessary have direct effects also on the stopping point of the respective other container. Apart from this, as a result of the use of the same measuring methods for different containers imprecise determination of the container type may occur, i.e. the containers cannot be clearly differentiated from one another. In the most unfavorable case, this may result in multiple occupations on the cycle belts which counteracts fault free operation of the system and prevents the throughput rate which the operator has been promised from being reached. This is the case also in particular because the containers which are of different sizes and thus weights, in particular laden containers, have different braking distances so that, for example, a container which stops quickly, i.e. prematurely, can occupy two cycle belts.

### SUMMARY OF INVENTION

The object of the present invention is to make available an improved solution for differentiating between different containers within a system and to ensure that the different containers can be reliably detected using simple means and can be stopped in a more positionally accurate fashion than in the past taking into account their differences in length and weight.

In order to achieve the object, the invention provides that, in order to detect and control specific containers, preferably the oversized ones, within the aircraft baggage conveyor system, a magnetic sensor system is provided between the container belt and the container. It is therefore proposed, in order to meet the requirements of the invention, that the mounting of additional photoelectric barriers for different container types be dispensed with and instead the detection and adjustment of a container type, preferably the OOG containers, be carried out by using a magnetic sensor. This additionally avoids irritations due to identical measuring methods at different containers, which makes fault free operation possible.

According to the invention, the magnetic sensor system is composed of a magnetic sensor which is arranged at a corresponding location on the container belt, and of a magnetic plate which is arranged on the underside of the shell of a container. The magnetic plate is preferably arranged in the region of the shell projecting beyond the metallic holder, on the protected underside of said shell. The use of a magnetic sensor which is configured in such a way permits not only the detection of the different container type by the sensor, it is also possible to adjust both stopping points independently of the container type and to adapt them to the respective requirements. Complex mounts for additional photoelectric light barriers are dispensed with, and instead small economical and clampable standard mounts can be applied.

According to a particularly favorable feature of the invention there is provision for the magnetic sensor to be connected to a relay for stopping the conveyor section which is carrying the container to be stopped. The stop signal (StopIni) is, according to the invention, not passed on to the stored program controller but rather goes directly to a relay which immediately switches off the drive of the corresponding conveyor. Delays due to the cycle time tolerance described at the beginning do not occur.

According to the invention, in addition to the signal to the relay, a further signal can be sent to the stored program controller as a message that a container is present at the registration point. The signal does not serve to position the container but rather functions merely as an occupation signal. The same also applies to the start signal (StartIni). In this way, the invention achieves complete decoupling of the start and stop processes with the associated cycle time tolerances.

According to the invention, the magnetic sensor and/or the magnetic plate are arranged in such a way that in each case only one of the different container types, preferably the oversized container is sensed by the magnetic sensor. The invention permits the various types of containers to be stopped in a producible fashion within a baggage conveyor system with minimum, i.e. tolerable deviations, of the stopping point which forms the basis for fault free running of the system. The tray can be positioned with the required accuracy of +/−30 mm. The solution dispenses with complex additional stopping devices for photoelectric barriers which are frequently repeated within the system. The invention provides an economical solution which is easy to implement.

### BRIEF DESCRIPTION OF THE DRAWINGS

The FIGURE shows in a highly simplified illustration of the inventive system.

### DETAILED DESCRIPTION OF INVENTION

The single FIGURE of the drawing shows in a highly simplified illustration a container B according to the invention which is composed of the shell 1 which is composed of plastic and a metallic holder 2 which carries the shell. The container B is moved along on the container path 3 in the direction 8 of the arrow, the container resting on a transportation belt (not illustrated) of a conveyor section. In order to position the container B at a provided location and to stop it there, it is necessary to send a stop signal to the conveyor section of the container path 3. This signal is triggered by the container itself, which, for this purpose, has a magnetic plate 4 in the section of the shell 1 which projects beyond the metallic holder 2, said magnetic plate 4 being mounted on the underside of the shell 1 in a protected region. The distance 6 between the magnetic plate 4 and the container path 3 is selected such that a magnetic sensor 5 which is provided in the region of the container path 3 on a holder (not illustrated) senses the presence of the magnetic plate 4 and is able to transmit a signal to stop the conveyor section. This signal can, for example, be transmitted directly to a relay for switching off the drive motor of the conveyor section so that the container B can be stopped without delay on the container path 3. The magnetic sensor is at a sufficient distance 7 from the metallic holder 2 when it senses the magnetic plate 4.

1.-6. (canceled)

7. An aircraft baggage conveyor system, comprising:
a container belt having individually controlled conveyor sections;
a plurality of containers of different sizes for holding and transporting pieces of baggage with different dimensions that successively moves through the system on the conveyor sections of the container belt, wherein the containers are each composed of a nonmetallic shell that holds a piece of baggage and is correspondingly dimensioned and a metallic holder for the shell;
photoelectric barriers that sense the presence of the containers;
a magnetic sensor system assigned to each container and the container belt; and
a stored program controller that receives input from the photoelectric barriers and the magnetic sensor system and control specific containers within the aircraft baggage conveyor system and specifies a container stopping point in the system.

8. The aircraft baggage conveyor system as claimed in claim 7, wherein the magnetic sensor system is composed of:
a magnetic sensor arranged at a corresponding location on the container belt, and
a magnetic plate arranged on an underside of the container shell.

9. The aircraft baggage conveyor system as claimed in claim 8, wherein the magnetic plate is arranged in a region of the shell projecting beyond the metallic holder, on the underside of the shell.

10. The aircraft baggage conveyor system as claimed in claim 9, wherein the magnetic sensor is connected to a relay for stopping the conveyor section that is carrying the container to be stopped.

11. The aircraft baggage conveyor system as claimed in claim 10, wherein the magnetic sensor and/or the magnetic plate are arranged such that in each case only one of the different container types is sensed by the magnetic sensor.

12. The aircraft baggage conveyor system as claimed in claim 11, wherein the magnetic sensor and/or the magnetic plate are arranged such that in each case only one of the oversized containers is sensed by the magnetic sensor.

13. The aircraft baggage conveyor system as claimed in claim 10, wherein the magnetic sensor outputs an occupied signal to the stored program controller as a message that a tray is present at a registration point.
